(19) United States
(12) Patent Application Publication
(10) Pub. No.: US 2012/0310446 A1
(43) Pub. Date: Dec. 6, 2012

(54) Murlin

(76) Inventor: Linda Murphy, Green Cove Springs, FL (US)

(21) Appl. No.: 13/474,848

(22) Filed: May 18, 2012

Related U.S. Application Data
(60) Provisional application No. 61/492,889, filed on Jun. 3, 2011.

(51) Int. Cl. G06F 17/00

(52) U.S. Cl. 701/2

(57) ABSTRACT

An architecture is presented that provides a handheld device designed for storing vehicle information. The handheld device comprises a fob comprising a first end and a second end, wherein a flash drive is removably secured to the first end of the fob. The flash drive stores vehicle information such as, engine size, vehicle identification number, license plate number, horsepower, oil preference, tire pressure and size, brake type, shocks, struts, date of the last oil change, and other vital information. Furthermore, the fob comprises at least one action button, such as an unlock, lock, or trunk control button, and a control button to release the flash drive from the fob. Additionally, the fob comprises a Bluetooth® transmitter and receiver that reads and transmits diagnostic vehicle problems to a user's cellular device or computer, where with the proper application, the diagnostic problem can be viewed by a user.

### CROSS-REFERENCE

This application claims priority from Provisional Patent Application Ser. No. 61/492,889 filed Jun. 3, 2011.

### BACKGROUND

It can be very difficult for individuals to remember all of the information pertaining to their vehicles, especially when the individuals own more than one vehicle. This can be embarrassing as well as inconvenient, as this vehicle information is needed when taking vehicles into the repair/service shop for repairs or services. For example, without having this vehicle information, the mechanics or service technicians may use the incorrect oil which can damage the vehicle, or they may perform an unnecessary maintenance function, which can be expensive. Additionally, the majority of individuals store this vehicle information in their glove compartments and thus, wouldn't be able to access the vehicle information if their vehicles were stolen. An effective solution is necessary.

There is a need for a way to store vehicle information, such as vehicle maintenance records, which is both accessible and portable. The present invention discloses a handheld, keyless door opener with a flash drive inside. The handheld device can store vehicle information, such as engine size, oil preference, and other vital information. The handheld device provides individuals with their vehicle information, causing users not to have to struggle to remember all of the details needed when getting their vehicles serviced or when the vehicles are in the repair shop. Users can simply download and display the vehicle information upon a computer, print it out, and give it directly to the mechanic, or the mechanic can use the flash drive, conveniently located with the keyless door opener, and directly pull up the vehicle information when needed. This allows services to be performed quicker and with more efficiency. Users will appreciate the convenience and practicality that this invention affords.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a handheld device designed for storing information about a vehicle. The handheld device comprises a fob comprising a first end and a second end. The handheld device further comprises a flash drive removably secured to the first end of the fob. The flash drive stores vehicle information such as, but not limited to, engine size, vehicle identification number, license plate number, horsepower, oil preference, tire pressure and size, brake type, shocks, struts, date of the last oil change, and other important and vital information.

Furthermore in the preferred embodiment of the present invention, the fob comprises at least one action button, such as an unlock button, a lock button and a trunk control button. The fob can then be used to remotely lock and unlock doors of a corresponding vehicle, and to remotely open and close a trunk of the corresponding vehicle. Additionally, the fob comprises a control button to release the flash drive from the fob. Pushing the control button, allows the flash drive to slide-out from the first end of the fob. The flash drive can then be retracted back into the fob by pushing the flash drive back into a recess of the fob. Furthermore, at least one key can be removably secured to the second end of the fob.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of a handheld device for storing vehicle information in accordance with the disclosed architecture.

FIG. 2 illustrates a perspective view of the handheld device with the flash drive protruding from one end of the fob in accordance with the disclosed architecture.

FIG. 3 illustrates a top, perspective view of the handheld device with the flash drive pushed into the fob in accordance with the disclosed architecture.

FIG. 4 illustrates a perspective view of the handheld device inserted into a computer in accordance with the disclosed architecture.

FIG. 5 illustrates a perspective view of a computer monitor displaying the contents of the flash drive of the handheld device in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention discloses a handheld device designed for storing vehicle information and for allowing the vehicle information to be accessible and portable to users. The handheld device discloses a fob with a flash drive inside. Specifically, the handheld device comprises a standard key fob with a slide-out Universal Serial Bus (USB) flash drive. The flash drive stores vehicle information, such as engine size, oil preference, and other vital information. The handheld device provides individuals with their vehicle information, causing users not to have to struggle to remember all of the details needed when getting their vehicles serviced or when the vehicles are in the repair shop. For example, when users take their vehicles to get serviced or repaired, the mechanics or technicians can take the key fob, eject the flash drive, and plug the flash drive into their computers. The computer will download the information, and provide the mechanics or technicians with the vehicles' exact specifications. This allows services and repairs to be performed quicker and with more efficiency. The key fob can also have a Bluetooth® receiver and transmitter. This receiver can pick up check engine light signals from a specified vehicle and send that signal to a locally used cellular device or computer by downloading the intended application to a user's cellular device or computer. This Bluetooth® receiver could also read the vehicles computer and transmit the problem code directly to a user's cellular device or computer. Thus, with the proper application, the check engine problem or other problem codes can be diagnosed and/or directly displayed on a user's cellular device or computer for viewing.

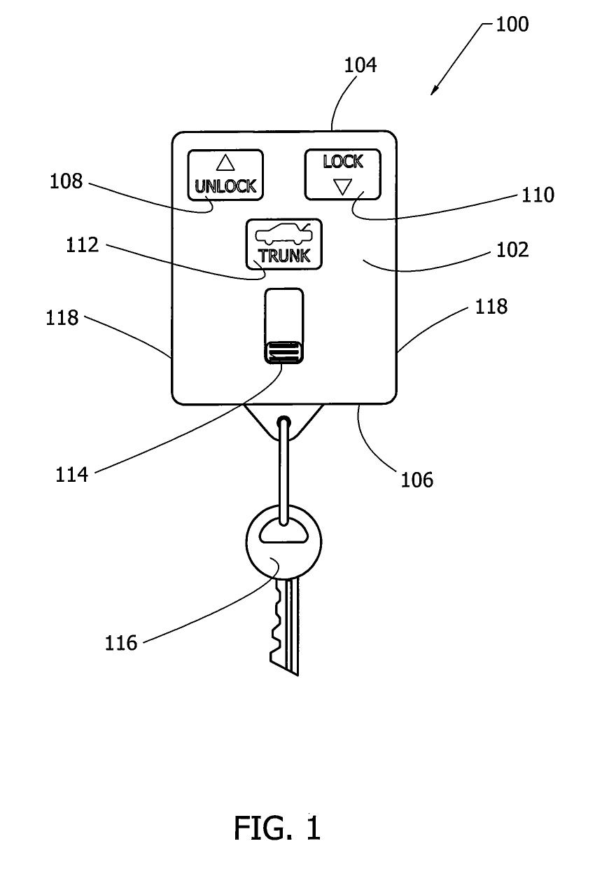

Referring initially to the drawings, FIG. 1 illustrates a perspective view of a handheld device 100 designed for storing vehicle information. The handheld device 100 comprises a fob 102 comprising a first end 104, a second end 106, and sides 118. Typically, the fob 102 is a generally rectangular-shaped object, however any other suitable shape, such as an oval, a square, etc., can be used as is known in the art without affecting the overall concept of the invention. The fob 102 would generally be constructed of plastic, such as acrylonitrile butadiene styrene (ABS) or polyvinyl chloride (PVC), or other polymers, though any other suitable material may be used to manufacture the fob 102 as is known in the art without affecting the overall concept of the invention. The fob 102 is approximately between 2.5 and 3 inches in length as measured from first end 104 to second end 106, approximately between 2 and 2.5 inches wide as measured between sides 118, and approximately between ¼ and ½ of an inch thick. However, the measurements would vary depending on the size and shape of the fob 102.

The fob 102 functions like a typically constructed fob as is known in the art, using radio waves, radio frequency identification (RFID), microwaves, etc., or any other suitable means for communicating. For example, the fob 102 comprises a transmitter or transponder which communicates with antennas located on the vehicle to transmit coded signals. A user has to be within a specific radio frequency communication range of the vehicle, so that communication can be made between antennas and the fob 102. Furthermore, the fob comprises at least one action button. When a user presses the action button, a coded signal is transmitted from the fob 102 to the vehicle to perform a specific action, such as unlock a door.

Additionally, the fob 102 has the appearance of a typically constructed fob as is known in the art, and comprises at least one action button as stated supra. For example, the fob 102 can comprise an unlock button 108, a lock button 110, a trunk control button 112, and a panic button (not shown). The fob 102 can then be used to remotely lock and unlock doors of a corresponding vehicle, and to remotely open and close a trunk of the corresponding vehicle, or to sound an alarm. Any number of action buttons which control various functions and/or objects of the corresponding vehicle can be positioned on the fob 102 depending on the wants and needs of a user.

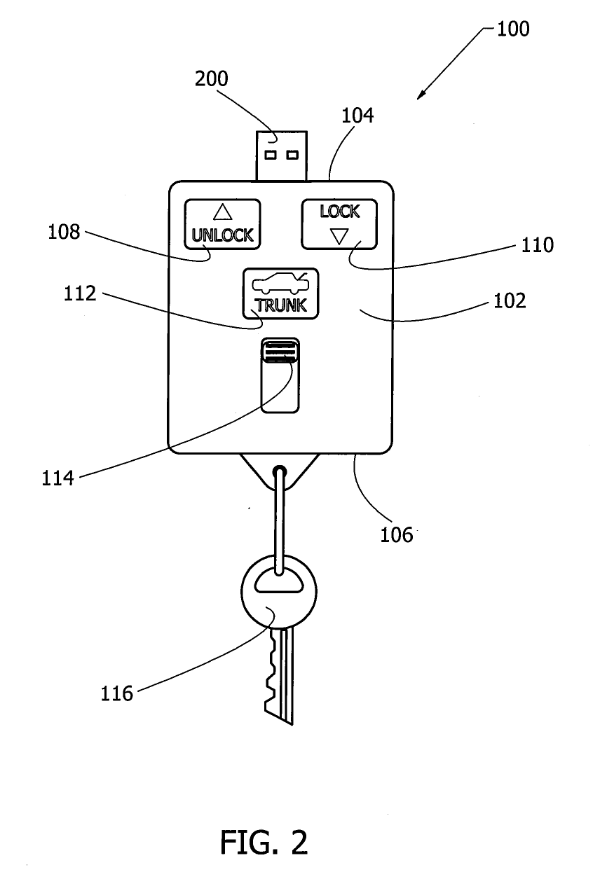

Furthermore, the handheld device 100 comprises a flash drive (See FIG. 2, 200) removably secured to the first end 104 of the fob 102. The flash drive stores vehicle information such as, but not limited to, engine size, oil preference, and other vital information. The flash drive functions as a typically constructed flash drive as is known in the art. For example, the flash drive comprises a mobile storage device and at least one interconnector. The mobile storage device has a connector at one end thereof which is in connection with a controller and a flash memory to create an electrical connection. Moreover, the connection interface of the connector juts outside the housing of the flash drive, and the outer end of the interconnector is constructed as a USB interface. The USB interface of the flash drive can then be inserted into a USB port or other similar port in a computer as is known in the art.

The fob 102 can also have a Bluetooth® (or other wireless technology) receiver and transmitter. This receiver can pick up check engine light signals from a specified vehicle and send that signal to a locally used cellular device or computer by downloading the intended application to a user's cellular device or computer. This Bluetooth® receiver could also read the vehicles computer and transmit the problem code directly to a user's cellular device or computer. Thus, with the proper application, the check engine problem or other problem codes can be diagnosed and/or directly displayed on a user's cellular device or computer for viewing.

Additionally, the fob 102 comprises a control button 114. The control button 114 is used to release the flash drive from the fob 102. Pushing the control button 114, allows the flash drive to slide-out from the first end 104 of the fob 102. The flash drive can then be retracted back into the fob 102 by pushing the flash drive back into a recess of the fob 102.

Furthermore, at least one key 116 can be removably secured to the second end 106 of the fob 102. The fob 102 can be a separate unit (stand-alone device) or can act as a keychain, wherein a plurality of keys 116 can be secured to the second end 106 of the fob 102. Additionally, the fob 102 can also comprise a key 116 secured to the second end 106 of the fob 102 as an integral unit.

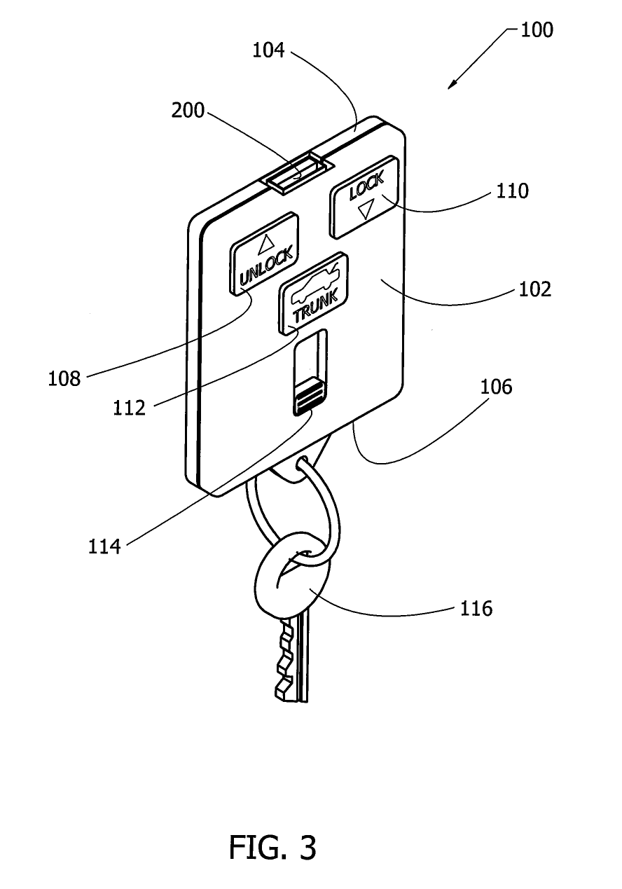

FIGS. 2-3 illustrate the handheld device 100 and attached flash drive 200. Specifically, FIG. 2 illustrates the handheld device 100 with the flash drive 200 protruding from the first end 104 of the fob 102 and FIG. 3 illustrates the handheld device 100 with the flash drive 200 retracted back into the fob 102. Further, the fob 102 can comprise at least one action button. For example, the fob 102 can comprise an unlock button 108, a lock button 110 and a trunk control button 112 for controlling the doors and trunk of a corresponding vehicle. The fob 102 can also comprise a control button 114. The control button 114 is used to release the flash drive from the fob 102. Pushing the control button 114, allows the flash drive to slide-out from the first end 104 of the fob 102. The flash drive 200 can then be retracted back into the fob 102 by pushing the flash drive 200 back into a recess of the fob 102.

Specifically when released, the flash drive 200 slides out and a substantial portion (approximately ¾th) of the flash drive 200 protrudes from the first end 104 of the fob 102, and an end portion of the flash drive 200 remains attached to the first end 104 of the fob 102. Thus, the flash drive 200 protrudes out a distance of approximately 0.5 inches from the fob 102. The end portion of the flash drive 200 is typically glued to the first end 104 of the fob 102, but can be secured by any other suitable means as is known in the art without affecting the overall concept of the invention. In contrast, the flash drive 200 can be unsecured to the first end 104 of the fob 102, such that when the control button 114 is depressed, the flash drive 200 slides out completely from the fob 102 as a separate, independent unit.

The flash drive 200 can then be inserted into a USB port or other similar port in a computer. Specifically, the mobile storage device of the flash drive 200 comprises a connector at one end thereof which is in connection with a controller and a flash memory to create an electrical connection and store information. The flash drive 200 stores a wide-range of information regarding the vehicle, such as, but not limited to, engine size, vehicle identification number, license plate number, horsepower, oil preference, tire pressure and size, brake type, shocks, struts, date of the last oil change, and other important and vital information. Once the flash drive 200 is inserted into a USB port or other similar port in a computer, the vehicle information can then be downloaded and displayed on the computer. The flash drive 200 can then be retracted back into the fob 102 by pushing the flash drive 200 back into the recess of the fob 102 (See FIG. 3) until secure. Typically, the information is initially inputted on the flash drive 200 directly by the manufacturer, but a user could also order the flash drive 200 from a specific web site to match a vehicle's vehicle identification number (VIN) number.

Furthermore, at least one key 116 can be removably secured to the second end 106 of the fob 102. The fob 102 can be a separate unit (stand-alone device) or can act as a keychain, wherein a plurality of keys 116 can be secured to the second end 106 of the fob 102. Additionally, the fob 102 can also comprise a key 116 secured to the second end 106 of the fob 102 as an integral unit.

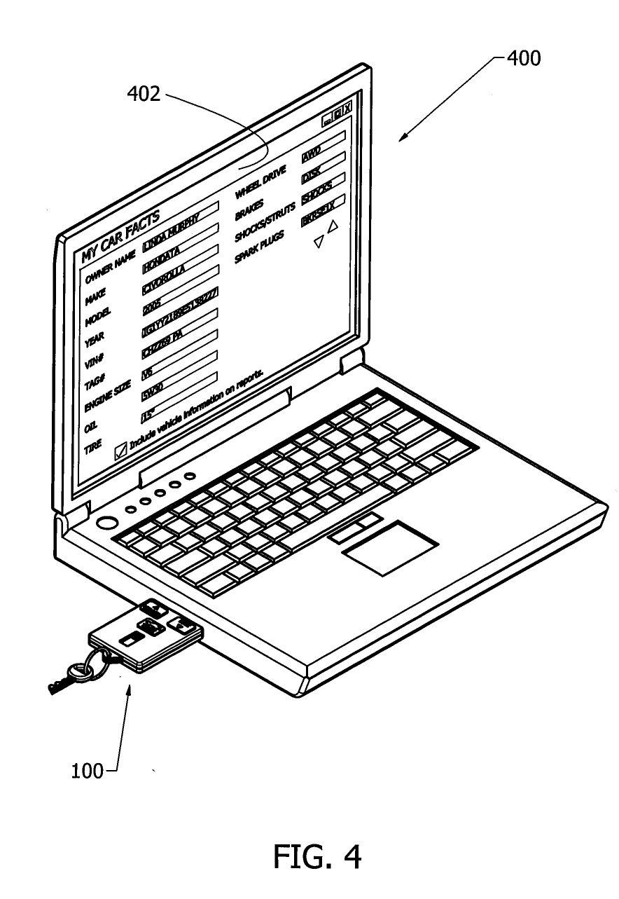

FIG. 4 illustrates the handheld device 100 in use, inserted into a computer 400. In operation, a user retrieves the handheld device 100 and presses the control button 114 to eject the flash drive from the device 100. Once the control button 114 is depressed, the flash drive 200 protrudes from the first end 104 of the fob 102, and an end portion of the flash drive 200 remains attached to the first end 104 of the fob 102. The user then inserts the flash drive into a USB port or other similar port of a computer 400. The flash drive can store a wide-range of information regarding the vehicle, such as, but not limited to, engine size, vehicle identification number, license plate number, horsepower, oil preference, tire pressure and size, brake type, shocks, struts, date of the last oil change, and other important and vital information.

The vehicle information can then be downloaded onto the computer 400 and then displayed on the computer monitor 402. The handheld device 100 is then removed from the USB port or other similar port, and then retracted back into the fob 102 by the user pushing the flash drive 200 back into the recess of the fob 102 until secure. Furthermore, mechanics or other vehicle technicians can take the handheld device, eject the flash drive, and plug the flash drive into their computers. The computer processor/drive will read the information stored on the flash drive, thus providing the vehicle's exact specifications.

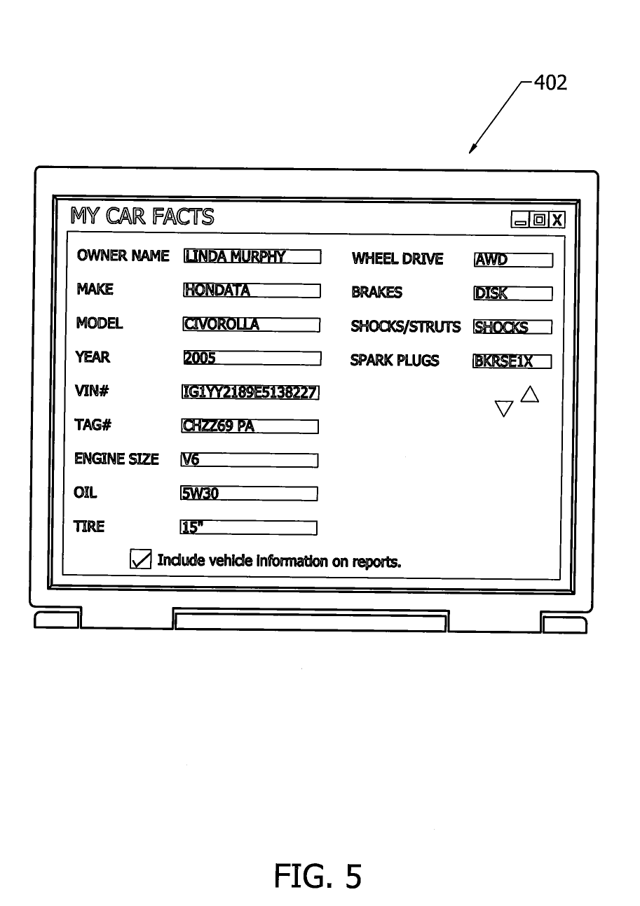

FIG. 5 illustrates a computer monitor 402 displaying the contents of the flash drive of the handheld device. As stated supra, a user can retrieve the handheld device, press the control button and eject the flash drive, and then plug the flash drive into a USB port or other similar port of a computer. The computer processor/drive can then read the information stored on the flash drive, and can download the information from the flash drive to the computer. The information can then be displayed on a computer monitor 402, providing the vehicle's exact specifications.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A handheld device for storing vehicle information, the device comprising:
a handheld fob comprising a first end and a second end; and
a flash drive removably secured to the first end of the fob.

2. The handheld device of claim 1, wherein the fob comprises lock and unlock buttons for a corresponding vehicle's doors.

3. The handheld device of claim 2, wherein the fob comprises a remote opening button for a trunk of the corresponding vehicle.

4. The handheld device of claim 1, wherein the fob comprises a control button which releases the flash drive when pressed.

5. The handheld device of claim 4, wherein when the control button is pressed the flash drive protrudes from the first end of the fob, a substantial portion of the flash drive slides-out from the first end of the fob and an end portion of the flash drive remains attached to the first end of the fob.

6. The handheld device of claim 5, wherein the flash drive can be secured within the fob by pushing the flash drive back into a recess on the first end of the fob.

7. The handheld device of claim 1, wherein the flash drive comprises vehicle information for a corresponding vehicle.

8. The handheld device of claim 7, wherein the vehicle information comprises at least one of an engine size, a vehicle identification number, a license plate number, horsepower, oil preference, tire pressure and size, brake type, shocks, struts, or date of last oil change.

9. The handheld device of claim 1, wherein at least one key is removably secured to the second end of the fob.

10. The handheld device of claim 1, wherein the flash drive is a USB flash drive.

11. A handheld device for storing vehicle information, the device comprising:
a handheld fob comprising a first end and a second end; and
a flash drive removably secured to the first end of the fob;
wherein the fob comprises vehicle door lock and unlock buttons, a remote opening trunk button, and a control button which releases the flash drive when pressed.

12. The handheld device of claim 11, wherein when the control button is pressed the flash drive protrudes from the first end of the fob and an end portion of the flash drive remains attached to the first end of the fob.

13. The handheld device of claim 12, wherein the flash drive can be secured within the fob by pushing the flash drive back into a recess on the first end of the fob.

14. The handheld device of claim 11, wherein the flash drive comprises vehicle information for a corresponding vehicle.

15. The handheld device of claim 14, wherein the vehicle information comprises at least one of an engine size, a vehicle identification number, a license plate number, horsepower, oil preference, tire pressure and size, brake type, shocks, struts, or date of last oil change.

16. The handheld device of claim 11, wherein at least one key is removably secured to the second end of the fob.

17. The handheld device of claim 11, wherein the fob and a key are an integral part (device).

18. A handheld device for storing vehicle information, the device comprising:
a handheld fob comprising a first end and a second end; and
a flash drive removably secured to the first end of the fob;
wherein the fob comprises vehicle door lock and unlock buttons, a remote opening trunk button, and a control button which releases the flash drive when pressed; and
wherein the flash drive comprises vehicle information for a corresponding vehicle.

19. The handheld device of claim 18, wherein the vehicle information comprises at least one of an engine size, a vehicle identification number, a license plate number, horsepower, oil preference, tire pressure and size, brake type, shocks, struts, or date of last oil change.

20. The handheld device of claim 18, further comprising a Bluetooth® transmitter and receiver that reads and transmits diagnostic vehicle problems to a user's cellular device or computer.
